(19) United States
(12) Patent Application Publication
(10) Pub. No.: US 2016/0151232 A1
(43) Pub. Date: Jun. 2, 2016

(54) HFCC THERAPY SYSTEM PROVIDING DEVICE ADHERENCE DATA

(71) Applicant: RespirTech, St. Paul, MN (US)

(72) Inventors: Robert CLAPP, Minneapolis, MN (US); Chad COLSCH, Minnetonka, MN (US)

(21) Appl. No.: 14/861,362

(22) Filed: Sep. 22, 2015

Related U.S. Application Data
(60) Provisional application No. 62/053,411, filed on Sep. 22, 2014.

(51) Int. Cl. A61H 9/00

(52) U.S. Cl. CPC A61H 9/0078

(57) ABSTRACT

A device and method coupled to a therapy garment to apply repetitive pressure pulses to a patient body, including a controller operable to regulate at least the duration of operation, frequency of the air pulses and selected air pressure applied to the patient. Aspects of the therapy system may be operable in accordance with operating parameters and a memory device captures session and summary data associated with one or more therapy sessions. The apparatus may comprise a wireless transmitter operable to wirelessly transmit session and summary data relative to one or more therapy sessions to a remote location.

### RELATED APPLICATION

This application claims the benefit of U.S. Provisional Application No. 62/053,411, filed Sep. 22, 2014, and incorporated herein by reference.

### BACKGROUND OF THE INVENTION

The present disclosure relates generally to high frequency chest compression (HFCC) therapy systems, and more particularly to an air pulse delivery system having multiple operating modes.

Manual percussion techniques of chest physiotherapy have been used for a variety of chronic lung diseases, such as cystic fibrosis, bronchiectasis, COPD, chronic bronchitis and a variety of pulmonary conditions resulting from neuromuscular disorders, that can benefit from airway clearance therapy to remove excess mucus that collects in the lungs. To bypass dependency on a caregiver to provide this therapy, chest wall oscillation devices have been developed to deliver HFCC therapy to a patient. A variety of high frequency chest compression (“HFCC”) systems have been developed to aid in the clearance of mucus from the lung. Such systems typically involve the use of an air delivery device, in combination with a patient-worn vest. Such vests were developed for patients with cystic fibrosis, and are designed to provide airway clearance therapy. The inflatable vest is linked to an air pulse generator that provides air pulses to the vest during inspiration and/or expiration. The air pulses produce transient cephalad air flow bias spikes in the airways, which moves mucous toward the larger airways where it can be cleared by coughing. The prior vest systems differ from each other, in at least one respect, by the valves they employ (if any), and in turn, by such features as their overall weight and the wave form of the air produced.

### SUMMARY OF THE INVENTION

The present invention is generally directed to a chest compression apparatus for applying a controlled force to the thoracic region of the patient and capturing therapy related information during a session and across multiple sessions.

The force applying mechanism includes a vest or other wearable air chamber for receiving pressurized air. The apparatus further includes a mechanism for supplying pressure pulses of pressurized air to the vest. For example, the pulses may have a sinusoidal, triangular, square wave form, etc. In a preferred embodiment of the present invention, a fan valve is used to establish and determine the rate and duration of air pulses entering the vest from the pressure side and allow air to evacuate the bladder on the depressurizing side. An air generator (e.g., blower) is used on the pressurizing side of the fan valve. The fan valve advantageously provides a controlled communication between the blower and the bladder.

A system in accordance with the present invention may include a housing, a therapy system carried by the housing and operable to deliver HFCC therapy to a patient in accordance with a set of operating parameters, and a memory configured to store at least a portion of the set of operating parameters. Device data is determined and stored in the memory and is available for review by the patient or caregiver. The data may be displayed on the HFCC system or may be communicated to a remote location. The therapy system may be operable in accordance with the portion of the set of operating parameters. A variety of data relating to the set of operating parameters may be stored for subsequent use or review.

An internal memory may store one or more of a plurality of pre-programmed therapy modes to allow a caregiver to deliver HFCC therapy to a patient in accordance with any one of the plurality of pre-programmed therapy modes stored in the memory. Alternatively or additionally, the memory may store one or more of a plurality of customized therapy modes to allow a caregiver to deliver a customized HFCC therapy to a patient in accordance with any one of the plurality of customized therapy modes stored in the memory.

A user interface apparatus of the therapy system may include a touch screen display. The display may be signaled by software of the therapy system to display a data download screen. The data download screen may comprise a patient list and a list of device selection buttons. The patient list may comprise patient ID numbers.

The data relating to HFCC therapy delivered to a patient may comprise one or more of the following: a type of the HFCC therapy, the settings of the various operating parameters associated with the HFCC therapy, data associated with any tests or assessments of the patient, including graphs and tables of such data, date and time of the therapy, and patient personal information. The data associated with a patient's assessment may comprise air flow data.

Device adherence summary data may include device serial number or unique ID number, days of use, sessions per day, minutes per day, average minutes per session and total average pressure. For each session date, the data may include start time, stop time, total time, therapy time, pause time, start pressure, end pressure, session average pressure, program selected, steps (pressure steps), number of pauses and termination type (completed, End used, Reset used). Pressure measurements may be actual pressure or relative pressure (10% to 100% max pressure). Average minutes per session, average pressure per session and total number of sessions may be provided on a display/menu screen for immediate review by the patient or caregiver. Fan frequency can be measured from valve motor hall sensors. Maximum and minimum frequency can be determined.

Software of the therapy system may include a subroutine to interface a memory device with a circuit of the therapy system to transfer data to and to retrieve data from the memory device. Alternatively or additionally, software of the therapy system may include a subroutine to interface the memory device with a memory of the therapy system to transfer data from the memory device.

The memory device may comprise a portable USB device, and the port may comprise a USB interface. The portable USB device may comprise a smart card, and the port may comprise a smart card interface. The smart card may be hot-swappable so that the smart card may be added to or removed from the apparatus without interfering with the operation of the therapy system. The smart card may be programmable so that it can be reconfigured to store a different therapy mode or a different set of functionalities available to a user. The memory device may be an Apple iPhone or Android device.

The apparatus may comprise a housing, a therapy system carried by the housing and operable to deliver HFCC therapy to a patient, and a wireless transmitter carried by the housing and operable to wirelessly transmit data relating to the HFCC therapy delivered to the patient to the wireless receiver of the device. The device may comprise a plurality of devices, with each device having a wireless receiver.

A user interface apparatus of the therapy system may comprise a touch screen display. The display may be signaled by software of the therapy system to display a data download screen. The data download screen may comprise a patient list and a list of device selection buttons. The patient list may comprise patient ID numbers.

A download confirm screen may be displayed on the display in response to selection of a device selection button on the data download screen. The download confirm screen may comprise a patient list that corresponds to a patient list on the data download screen, a confirm button, and a cancel button. A wireless transmitter may be signaled by the software of the therapy system to wirelessly transfer a patient's data to the selected device in response to selection of the confirm button.

The apparatus may further comprise a wireless receiver carried by the housing and operable to wirelessly receive updates relating to software of the therapy system. Additionally or alternatively, the receiver may be operable to wirelessly receive updates relating to problem diagnoses. The wireless transmitter and/or the wireless receiver may be included as part of a wireless transceiver. Alternatively, the housing may include a data port to receive updates relating to software of the therapy system and/or updates relating to problem diagnoses. The wireless transmission of the data may be in accordance with any protocol, including the following protocols: IrDA, spread spectrum (including the Bluetooth protocol), RS232, TCP/IP, USB, 802.11, and the like.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1-2 are perspective illustrations of an air system embodiment in accordance with the present invention.

FIG. 3 is a depiction of functional aspects of an air system according to the present invention, with arrows depicting air flow there through.

FIG. 4 is a side elevational view of a portion of a blade valve suitable for use with an embodiment of the present invention.

FIG. 5 is another side elevational view of a blade valve of FIG. 4.

FIG. 6 is a top plan view of a rotationally balanced blade suitable for use within a rotary blade valve including within an embodiment of the present invention.

FIG. 7 is a cross sectional view of the blade of FIG. 6, taken along lines 4-4.

FIG. 8 is a perspective view of the pulse frequency module 14.

FIG. 9 is a perspective view of the pulse frequency module 14 of FIG. 8 with a portion removed to expose fan blade 20.

FIG. 10 is an exploded perspective view showing various components of the HFCC air system of FIG. 1.

FIG. 11 is a perspective view of portions of the HFCC air system of FIG. 1.

FIG. 12 is a perspective view of portions of the HFCC air system of FIG. 1.

FIG. 13 is a perspective view of portions of the HFCC air system of FIG. 12.

FIG. 14 is a perspective view of portions of the HFCC air system of FIG. 1.

FIG. 15 is a perspective view of portions of the HFCC air system of FIG. 1.

FIG. 16 is a functional schematic of the system of FIG. 1.

FIG. 17 illustrates device adherence data relating to use of an HFCC.

### DETAILED DESCRIPTION OF THE INVENTION

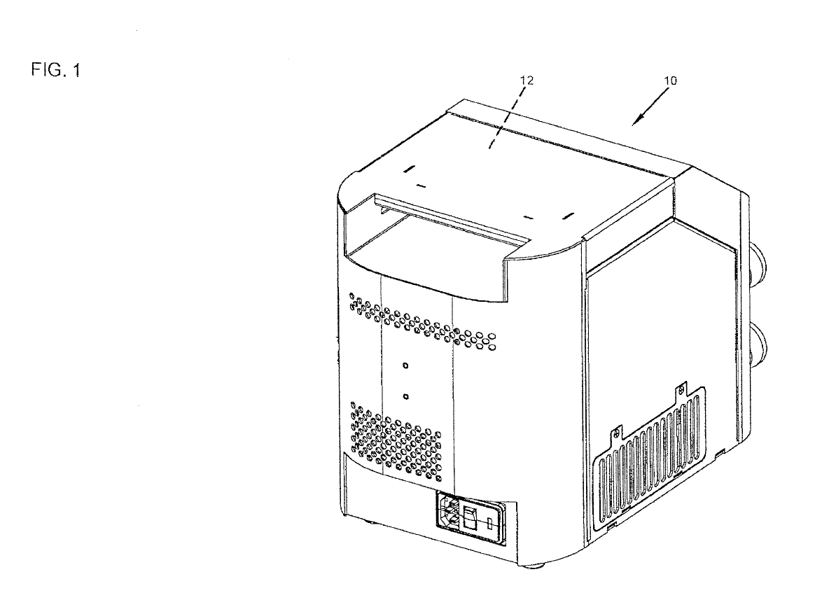

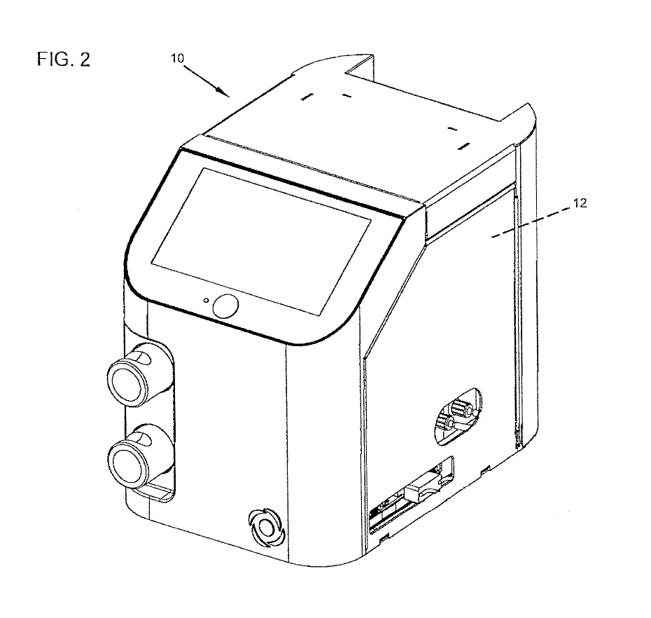

An embodiment of a chest compression system according to the present invention is referenced herein by the numeral 10. FIGS. 1-2 illustrate perspective views of an exemplary embodiment of system 10. As described in greater detail herein, system 10 includes an air flow generator 12 providing intermittent pulses to a patient vest (not shown) during a therapy session.

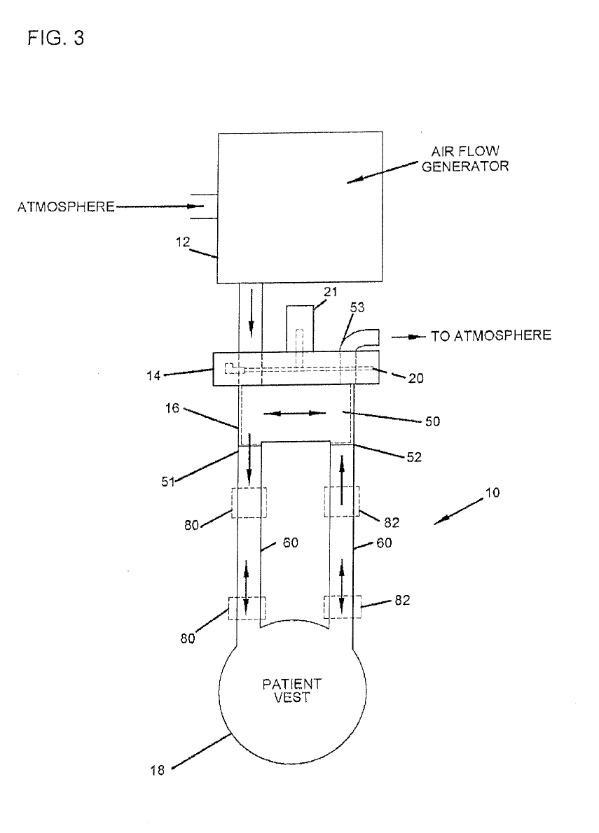

FIG. 3 is a somewhat diagrammatical air flow diagram associated with system 10. System 10 includes an air flow generator component 12, flowably connected to a pulse frequency control module 14, which in turn is flowably connected to a pressure control device 16, and finally to a vest 18 worn by the patient. The patient may be a human or other animal. For example, both human and equine applications may be practicable, with differently sized vests 18 being defined by the particular applications. In use, the air flow generator (e.g., motor driven blower) delivers pressurized air to vest 18, via pulse frequency control unit 14 that preferably includes one or more rotating (e.g., fan-like) blades. Air flow generator 12 includes an electric blower, the speed of which may be fixed or variable depending on an application. A controller 160 controls a speed of the electric blower to control the pressure applied during an HFCC session.

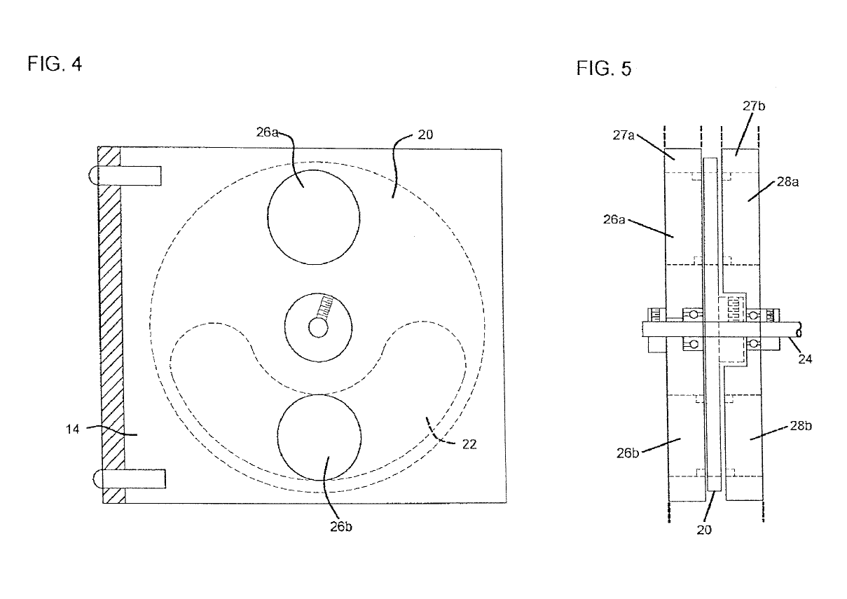

FIGS. 4-5 illustrate pulse frequency control unit 14. Unit 14 includes a generally circular valve blade 20, rotatable upon a central axis of motor 21 and having one or more cutout portions 22. Blade 20 is retained on a centrally located motor driven shaft 24, which serves to rotate blade 20, and in turn, provide airflow access to and through air ports 26 a and 26 b, respectively. Motor 21 is coupled to motor shaft 24 and provides rotational control of blade 20. Motor 21 is a stepper motor providing accurate control of blade 20 position in order to define particular waveforms applied to vest 18. As shown in corresponding FIG. 5, a pair of plates 27 a and 27 b are mounted on an axis concentric with that of motor drive shaft 24, and effectively sandwich the blade assembly between them. The end plates are provided with corresponding air ports 26 a and 26 b (in plate 27 a) and 28 a and 28 b (in plate 27 b). The air ports are overlapping such that air delivered from the external surface of either end plate will be free to exit the corresponding air port in the opposite plate, at such times as the blade cutout portion of the valve blade is itself in an overlapping position therebetween. By virtue of the rotation of cutout portions past the overlapping air ports, in the course of constant air delivery from one air port toward the other, the rotating fan blade effectively functions as a valve to permit air to pass into the corresponding air port in a semi-continuous and controllable fashion. The resultant delivery may take a sinusoidal wave form, by virtue of the shape and arrangement of the fan blade cutout portions.

Pulse frequency module 14, in a preferred embodiment, is provided in the form of a motor-driven rotating blade 20 (“fan valve”) adapted to periodically interrupt the air stream from the air flow generator 12. During these brief interruptions air pressure builds up behind the blade. When released, as by the passage of blade 20, the air travels as a pressure pulse to vest 18 worn by the patient. The resulting pulses can be in the form of fast rise, sine wave pressure pulses. Alternative waveforms can be defined through accurate control of blade 20, such as via an electronically controlled stepper motor. These pulses, in turn, can produce significantly faster air movement in the lungs, in the therapeutic frequency range of about 5 Hz to about 25 Hz, as measured at the mouth. In combination with higher flow rates into the lungs, as achieved using the present apparatus, these factors result in stronger mucus shear action, and thus more effective therapy in a shorter period of time.

Fan valve 20 of the present invention can be adapted (e.g., by configuring the dimensions, pitch, etc. of one or more fan blades) to provide wave pulses in a variety of forms, including sine waves, near sine waves (e.g., waves having precipitous rising and/or falling portions), and complex waves. As used herein a sine wave can be generally defined as any uniform wave that is generated by a single frequency, and in particular, a wave whose amplitude is the sine of a linear function of time when plotted on a graph that plots amplitude against time. The pulses can also include one or more relatively minor perturbations or fluctuations within and/or between individual waves, such that the overall wave form is substantially as described above. Such perturbations can be desirable, for instance, in order to provide more efficacious mucus production in a manner similar to traditional hand delivered chest massages. Moreover, pulse frequency module 14 of the present invention can be programmed and controlled electronically to allow for the automatic timed cycling of frequencies, with the option of manual override at any frequency.

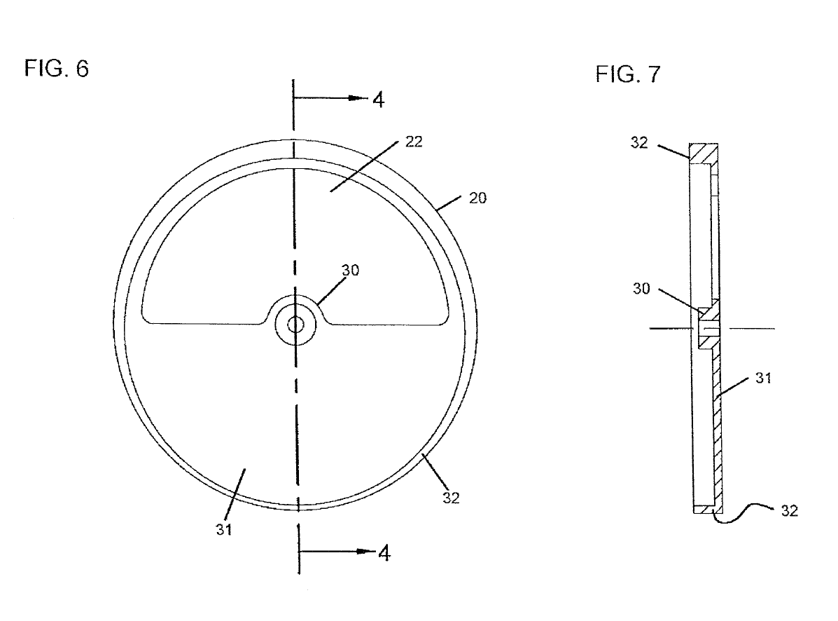

Referring to FIGS. 6-7, fan valve 20 includes hub 30, a base plate element 31 and a variable thickness outer wall 32. Outer wall 32 is thinner in the region generally opposite cutout portion 22 and thicker proximate to the cutout portion 22. Preferably the outer wall 32 thickness is varied in order to statically and dynamically balance the fan valve 20. By balancing fab valve 20, a reduction in vibration and noise can be provided. One or more Hall effect sensors may be used with fan valve 20 or valve motor 21 to monitor rotational speed or frequency.

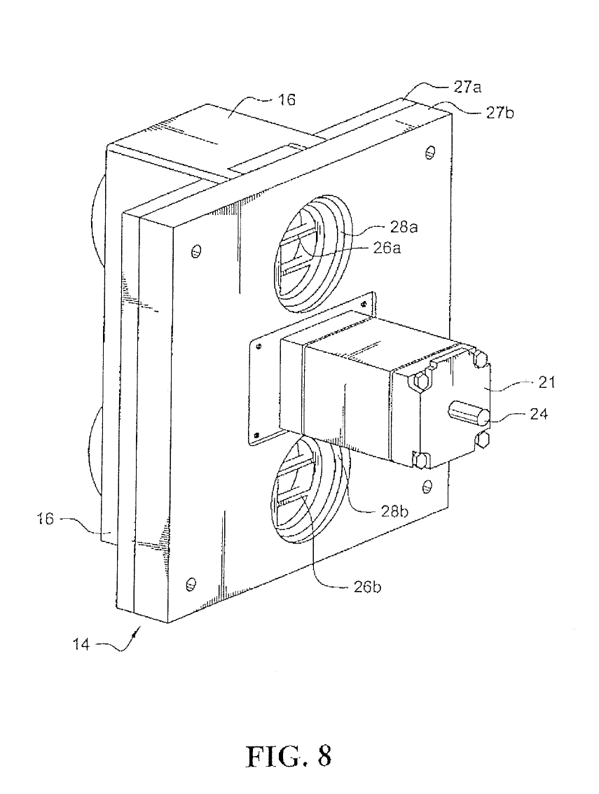

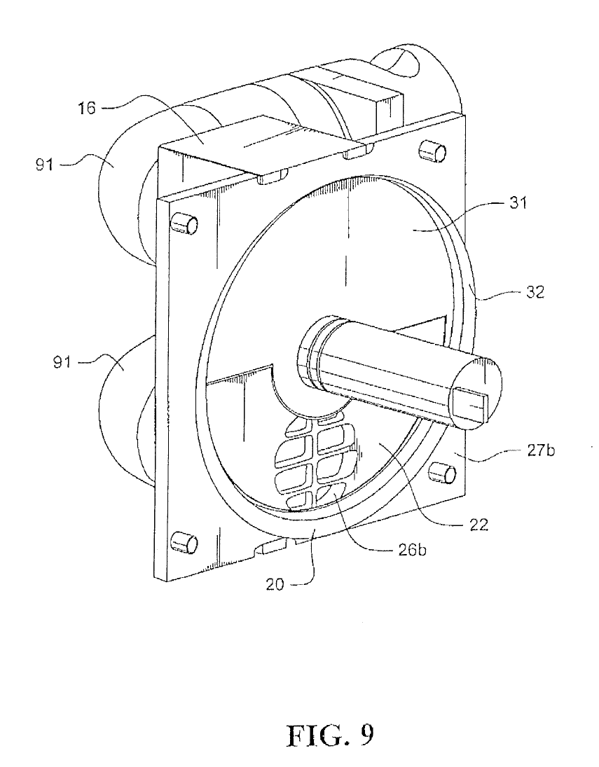

Referring to FIGS. 8-9, pressure control unit 16 defines a balancing chamber/manifold 50 in air communication with ports 26 a and 26 b of module 14. Chamber 50 is adapted to receive or pass air through ports 26 a and 26 b of pulse frequency control module 14, and effectively provides a manifold or air chamber to deliver air to vest 18 or atmosphere by means of vest exit ports 51, 52 and atmosphere exit port 53. As depicted in FIG. 3, air manifold 50 of pressure control unit 16 defines a fluid communicating bypass between ports 51 and 52, and hence fluid communication between the ports of pulse frequency control module 14 and air lines 60 to patient vest 18. During operation, air chamber 50 receives HFCC pulse pressure waves through ports 26 a, 28 a. Port 53 is connected to port 28 b of frequency control module 14 and is closed to atmosphere when 26 a is open and open when 26 a is closed. Ports 51 and 52 are connected to the inflatable vest 18 via flexible tubing 60.

Pulse pressure control 16 is located between frequency control module 14 and vest 18 worn by the patient. In the illustrated embodiment, air chamber 50 of pulse pressure control 16 is immediately adjacent pulse frequency control module 14. In one preferred embodiment, a structure defining the air chamber is directly connected to the outlet ports of the pulse frequency control module 14. The manifold or air chamber 50 provides fluid communication between air lines 60 extending to vest 18 and the bladder-side ports of the pulse frequency control module 14. Pressure control unit 16 may be active or passive. For example, an active pressure control unit may include, for example, valves and electric solenoids in communication with an electronic controller, microprocessor, etc. A passive pressure control unit 16 may include a manual pressure relief or, in a simple embodiment, pressure control unit 16 may include only the air chamber providing air communication between the air lines extending to the vest 18 and not otherwise including a pressure relief or variable pressure control.

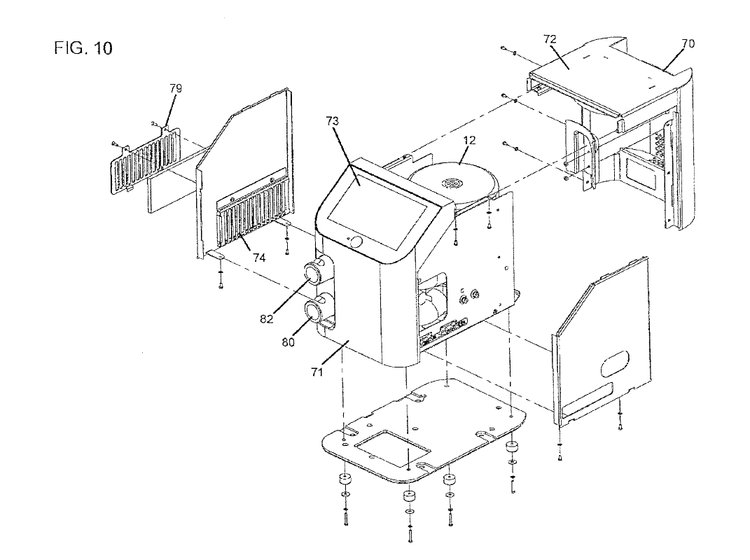

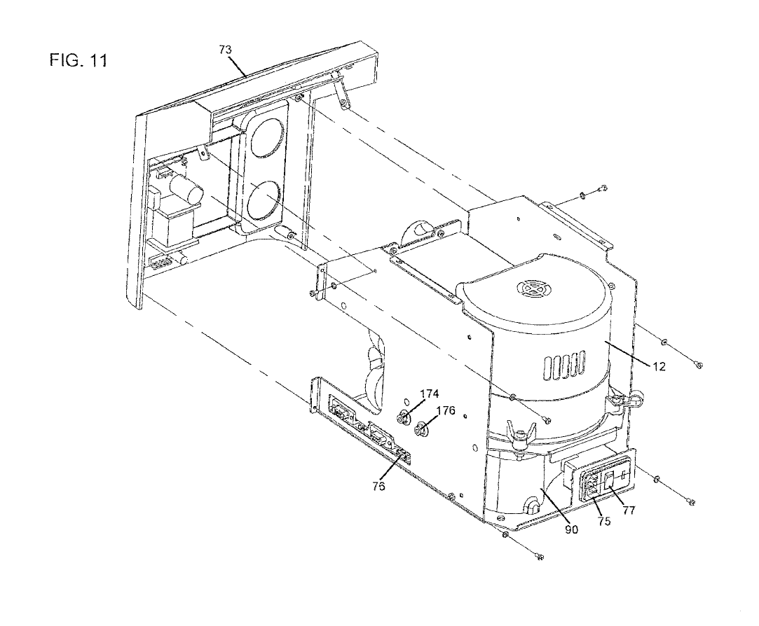

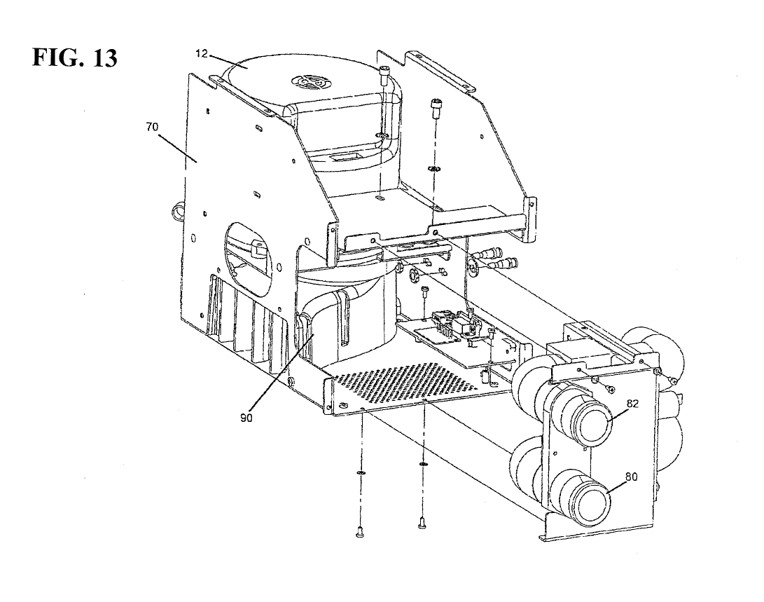

FIGS. 10-13 illustrate external and internal aspects of system 10. System 10 includes shell or housing 70 having front portion 71 and top portion 72. Front portion 71 includes a user interface including display 73. System 10 defines air openings 74, electrical connection 75, telecom connections 76, and power switch 77. User interface includes a visual display 73 which allows the patient to control device 10. Air openings 74 permit air entry into system 10. A removable filter 79 is adapted to be periodically removed and cleaned to minimize debris entry into system 10.

System 10 further includes a plurality of quick connect air couplings 80, 82 which couple vest 18 with system 10 via air hoses 60. Each quick connect air coupling 80, 82 includes male and female portions and a latch or other release for quickly disconnecting the portions. The benefits of the quick connect air couplings include minimization of inadvertent air hose disconnects and improved freedom of movement as the locking air coupling permit rotation between the air hose and the vest or air generator.

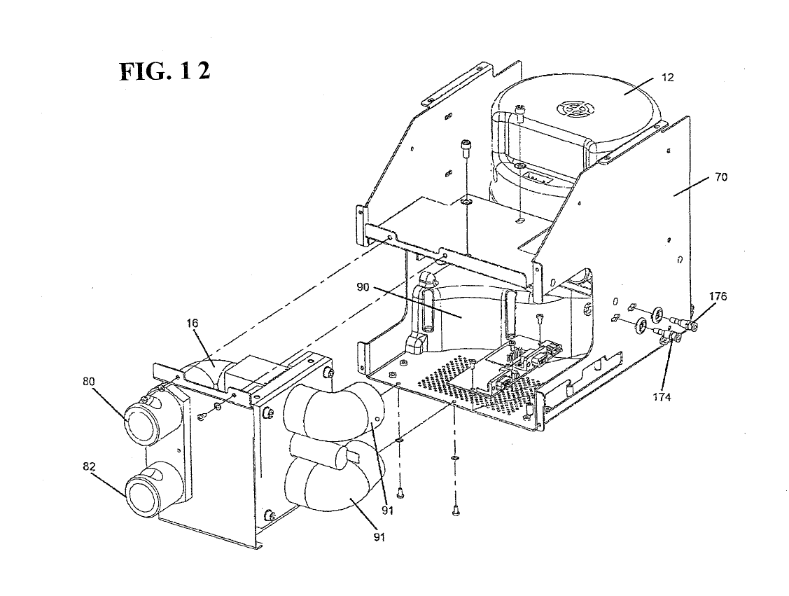

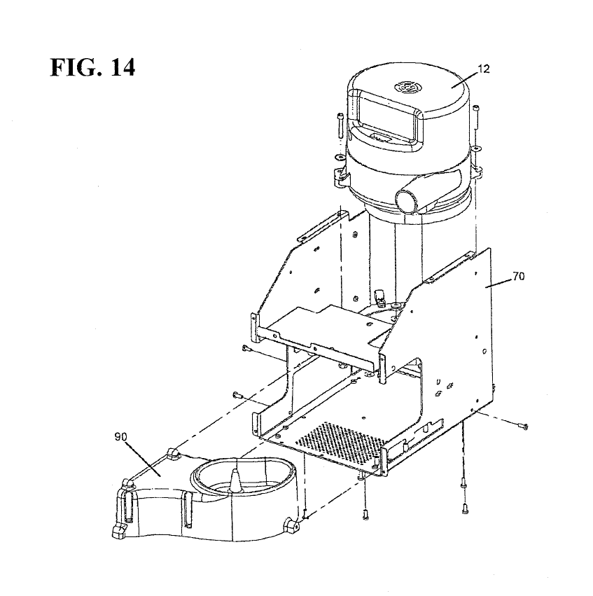

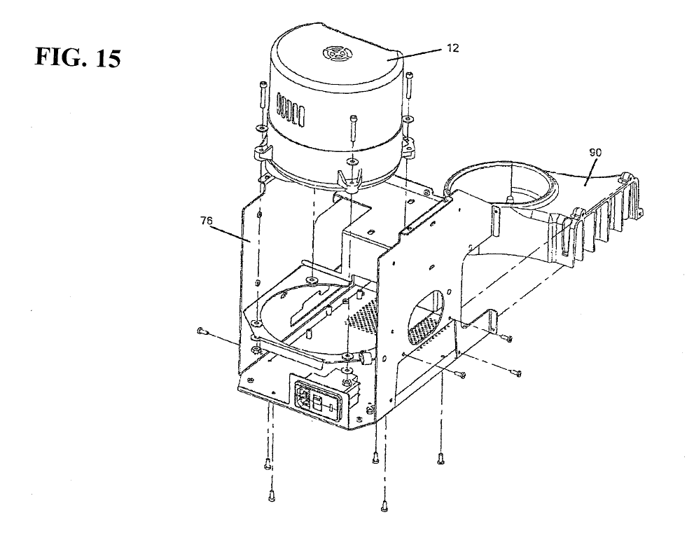

As shown in FIGS. 12-15, plenum 90 is defined between an inlet port of air flow generator 12 and external housing 70. Plenum 90 defines an air conduit between for air entering system 10. Plenum 90 includes a pair of openings, one positioned near opening 74 and the other positioned at an inlet to the electric blower motor of air flow generator 12. Plenum 90 is provided with a generally decreasing cross sectional volume as it extends from air opening 74 towards the inlet of air flow generator 12. Plenum 90 promotes a reduction in sound generation as air is more efficiently drawn into generator 12 as compared to an open fan inlet. Tubular couplings 91 provide fluid communication to air flow generator 12 to control devices 14, 16 and quick connect air couplings 80, 82.

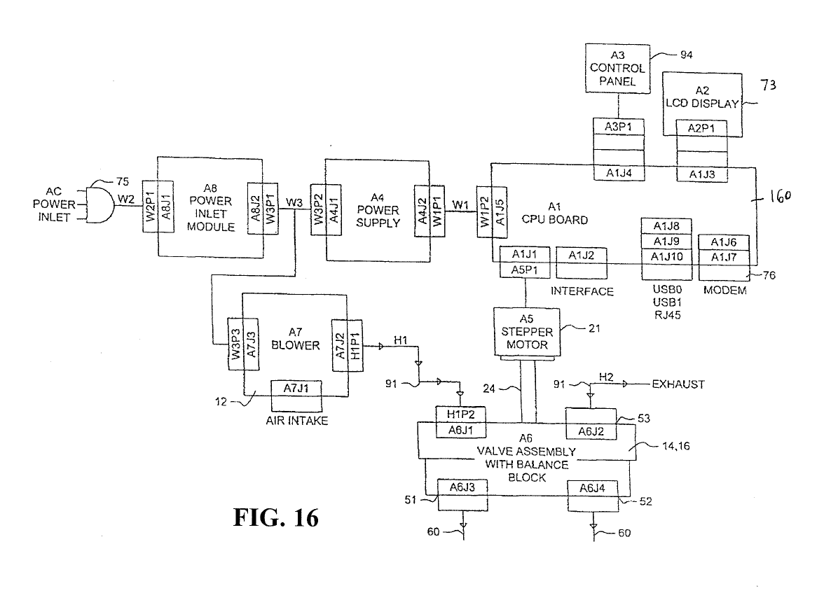

FIG. 16 illustrates a somewhat diagrammatical schematic of system 10. Controller 160 is connected to modem interface 76 permitting communication to and from system 10 to a remote location. Examples of communication include monitoring of system 10 performance, updating software used by controller 160 monitoring patient compliance, performing remote system diagnostics, etc. Controller 160 provides control of stepper motor 21 providing rotational control to blade 20.

Various user interfaces allows the patient to control system 10. System 10 activation/deactivation is controlled through on/off switch 77. The user interface includes touch-sensitive display panel 73. Display panel 73 is preferably an LCD panel display, although other displays could also be used. Display panel 73 shows the status of system 10 and options available for usage, optimization and/or modification of system 10. System 10 also provides a variety of feed back to the patient as to system status, blood oxygen saturation, lung function trending, etc. For example, the display 73 may be utilized to coordinate usage of the pulse oximeter and mouthpiece sensor 8 during therapy sessions. Data may be collected by the system 10 relating to system use, operation, errors, status, patient compliance and a variety of patient physiological data. Data may be transferred from system 10 to a remote system via various wired or wireless means, including but not limited to BLUETOOTH transmissions and removable memory appliances. Data across multiple systems may be utilized in outcome assessments.

In a related manner, update information may be stored on a removable memory device and transferred to system 10 or transmitted wirelessly directly to system 10 from a remote source. The updated information may include operating software, software updates, etc. In one embodiment, a removable memory appliance may be used to transmit data both to/from a remote system, the data including patient and system data and update information.

HFCC therapy is prescribed as either an adjunct or outright replacement for manual chest physiotherapy. Total therapy time per day varies between about 30 minutes and about 240 minutes spread over one to four treatments per day. Patients can be instructed in either the continuous intermittent mode of HFCC therapy, which may include continuous use of aerosol.

System 10 is provided in the form of a compact air pulse delivery apparatus. An air flow generator module 12 is provided in the form of a compressor, and is enclosed in a compartment having air inlet and outlet ports. The air inlet port can be open to atmosphere, while the outlet port can be flowably coupled to the pulse frequency control module. In another embodiment, the air flow generator module 12 may include a variable speed air fan adapted to be used with an electronic motor speed controller. In such an embodiment, the amplitude of pulses transmitted to the air vest 18 may be controlled by adjusting the fan motor speed, for example via controller 160.

System 10 may include one or more display screens allowing the caregiver to control the operation of any of the additional respiratory therapy system(s) and/or assessment system(s) included in system 10. The set of operating parameters may be stored in the on-board memory associated with the controller or microprocessor. The system housing has two large air ports which are configured to be coupled to a HFCC therapy garment via hoses. The garment has at least one bladder and is configured to be positioned on a patient receiving HFCC therapy. An example of a garment suitable for use with the system is disclosed in U.S. Ser. No. 13/850,286, which is hereby incorporated by reference herein. In response to user inputs, the controller signals air pulse generator to deliver high frequency air pulses to the patient in accordance with a set of operating parameters.

The controller of system 10 signals the air pulse generator to deliver high frequency air pulses to a patient in accordance with the portion of the set of operating parameters stored in a memory device. In some embodiments, the memory device is configured to store one or more of a plurality of pre-programmed therapy modes to allow a caregiver to deliver HFCC therapy to a patient in accordance with any one of the plurality of pre-programmed therapy modes stored in the memory device. Examples of the pre-programmed therapy modes include a step program mode, a sweep program mode, a training program mode, and the like. A program mode allows the caregiver to start at a desired starting frequency and/or intensity for the HFCC therapy and automatically gradually increase the frequency and/or intensity over a predetermined period of time or a programmed period of time to a desired maximum frequency and intensity.

System 10 may include a memory device configured to store one or more of a plurality of therapy modes to allow a caregiver to deliver HFCC therapy to a patient in accordance with any one of the plurality of therapy modes stored in the memory device. In the custom program mode, the caregiver is able to create a special waveform for a particular patient's therapy. Such a special waveform may be in accordance with wave type, frequency, pressure, and timing parameters of the caregiver's choosing or may be in accordance with a menu of special waveforms preprogrammed into the system. In still other embodiments, a memory device is configured to store information regarding functionalities available to a patient. Examples of functionalities available to a patient include one or more of a positive expiratory pressure (PEP) therapy, a nebulizer therapy, an intermittent positive pressure breathing (IPPB) therapy, a cough assist therapy, a suction therapy, a bronchial dilator therapy, and the like.

In the illustrated embodiment, controller 160 includes a microprocessor. Software of system 10 is stored in one or more on-board memories associated with the microprocessor. The microprocessor executes the software to cause various screens and various data to appear on a display screen. The display screen allows the caregiver to control the operation of air pulse generator to deliver HFCC therapy to a patient in accordance with a set of operating parameters, such as the frequency of air pulses, the amplitude of the air pulses, the duration of the HFCC therapy, just to name a few. In some embodiments, the frequency of air pulses is variable between about 0 Hz to about 20 Hz, the steady state pressure of air pulses is variable between 10% and 100% (of max pressure), and the duration of the HFCC therapy is variable between about 5 minutes and about 60 minutes. Other embodiments may have minimum and maximum operating parameters that are different than these listed values.

The set of operating parameters may be stored in the on-board memory associated with the microprocessor. Additionally or alternatively, a portion of the set of operating parameters may be stored in a memory device configured to be coupled to the microprocessor via an input port. Such a memory device can include an external USB device with an input port being externally accessible. Examples of such a memory device include a smart card, an iButton® device, a Memory Stick® device, and the like.

As indicated, system 10 includes software that is stored in one or more memories associated with controller 160 that, when executed, causes various user interface screens to be displayed on a display screen at different times depending upon user inputs to system 10.

In some embodiments, the data stored in system 10 is transmitted via a wired connection to an associated device coupled to system 10. Additionally or alternatively, system 10 may be coupled either wirelessly and/or via a wired connection to a network of computer devices, such as local area network (LAN), a wide area network (WAN), an Ethernet of a healthcare facility, or the Internet. A destination ID may be programmed into system 10 or entered by a user to specify a device of the network to which the data from system 10 is to be transmitted.

During a therapy session data can be collected and stored in a device memory. At the end of a session summary data can be calculated and displayed on a display screen and/or communicated to a remote system, network, etc. Session data and/or summary data can be downloaded via USB, Bluetooth, Wi-Fi or other connection means into Microsoft Excel file, other file type or database that can be accessed for reporting or presentation.

System 10 session data may include:
User ID—a unique identification code associated with a patient
Device number—unique identification code associated with the device
Start and stop date of session—date information of session
Start time—time of session start
Stop time—time of session stop
Total time—difference between stop time and start time
Pause time—time device is paused during session
Therapy time—total time (stop time−start time) less pause time, or duration of therapy
Start pressure—session initial pressure (e.g., 10%-100% of max)
End pressure—session end pressure (e.g., 10%-100% of max)

Average pressure—true average pressure (Σ(pressure×time))/Σtime
Program—program used during session, e.g., Quick Start, Auto Pause, Multi-Step #1, #2 or #3
Maximum measured frequency from valve motor hall sensor
Minimum frequency setting for session
Maximum frequency setting for session
Number of program steps performed
Number of pauses initiated (manual or automatic)
Termination type (session completed, END used or RESET used)

Depending on the application, some of the above device data memory can be reset (zeroed) either by a user or other device manager. In some applications, it may be desirable to reset information stored in memory, for example to comply with applicable data privacy regulations, etc. An internal “hour meter” may be prevented from reset as desired.

A “Session” can be arbitrarily defined to include at least X minutes of therapy time. For example, a session can be defined to include at least 4.5 minutes of therapy time.

Summary data for multiple sessions can be displayed on device screen or called up from a menu option. The summary data may include:
Days of use (up to X days or Y sessions)
Sessions per day (shown as an average)
Total number of sessions
Minutes per day (shown as an average)
Minutes per session (shown as an average)
Average pressure (shown as an average)—true average pressure either in percent of maximum or real pressure e.g. psi.

Summary data for one or more previous sessions can be displayed on a display screen or available for call up from a menu option for after last session, and may include:
User ID and/or Device ID
Date of session (Start and Stop)
Program used
Total time of session
Total runtime of session (excluding pause time)
Total pause time of session
Number of pauses per session
Number of steps in session
Average pressure of session

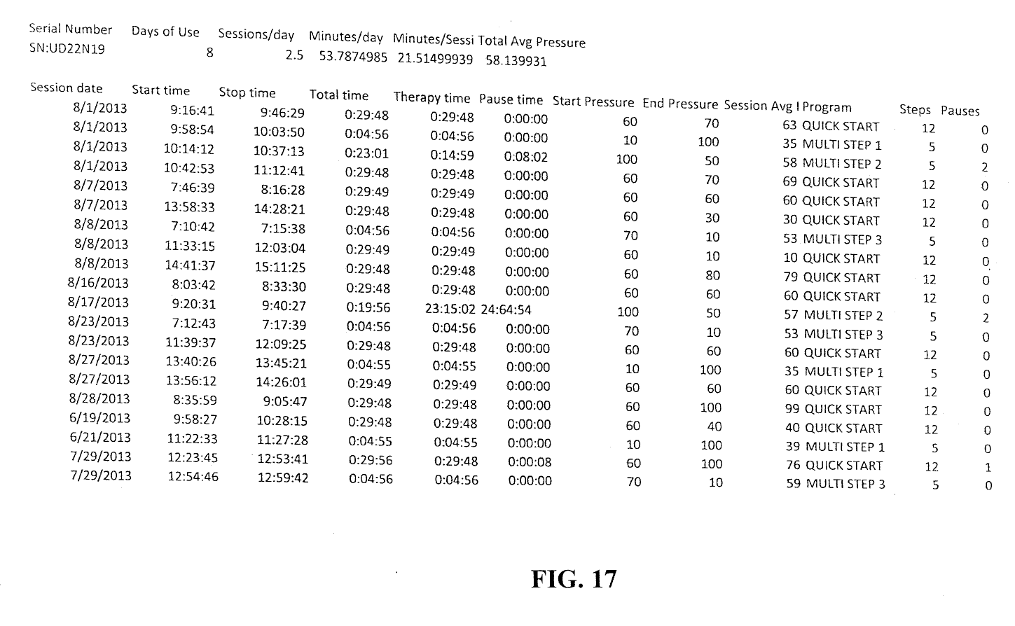

FIG. 17 illustrates device adherence data relating to use of system 10 by a patient over an 8 day period of time. Data includes device serial number, days of use, sessions per day, minutes per day, average minutes per session and total average pressure. For each session date, the data includes start time, stop time, total time, therapy time, pause time, start pressure, end pressure, session average pressure, program selected, steps (pressure steps), and pauses.

Pressure measurements may be actual pressure or relative pressure (10% to 100% max pressure). In the illustrated data set of FIG. 17, pressure data included relative pressure readings.

Average minutes per session, average pressure per session and total number of sessions may be provided on a display/menu screen for immediate review by the patient or caregiver.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A HFCC therapy system comprising:
a garment having an air bladder adapted to engage at least a portion of a patient;
an air pulse system including a controlled air fan creating a pulsed air flow;
a controller for operating the air pulse system to vary an air flow applied to the garment; and
a display for conveying device session or summary data to the patient or caregiver, said data including information relating to use of the system by the patient over a period of time.

2. The HFCC therapy system of claim 1 wherein the device summary data includes: average minutes per session, average pressure per session and number of sessions used.

3. The HFCC therapy system of claim 1 wherein the device summary data is determined from one or more of the following: date of session, start time, stop time, total time, therapy time, pause time, start pressure, end pressure, average pressure and program used.

4. The HFCC therapy system of claim 1 wherein session or summary data for one or more sessions is available for display or communication to a remote location.

5. The HFCC therapy system of claim 4 wherein the session data includes: user ID, program used, total time of session, total run time of session, total pause time of session, number of pauses per session, number of steps, average pressure of session.

6. The HFCC therapy system of claim 1 wherein data for multiple prior sessions is available and includes: days of use, sessions per day, minutes per day, minutes per session, and average pressure.

7. A HFCC therapy system comprising:
a garment having an air bladder adapted to engage at least a portion of a patient;
an air pulse system including a controlled air fan creating a pulsed air flow;
a controller for operating the air pulse system to vary an air flow applied to the garment; and
a display for conveying session and summary data to the patient or caregiver, said session data relates to a prior therapy session and includes date, start/stop times, therapy time, pause time, start/end pressures and program used, and said summary data relates to multiple prior therapy sessions and includes days of use, average sessions per day, average minutes per day, average minutes per session, average pressure.

8. The HFCC therapy system of claim 7 wherein session and summary data is available for download to an external memory device or for communication to a remote device.

9. The HFCC therapy system of claim 7 wherein the summary data further includes a user identification number, total pause time, average number of pauses per session and number of pressure steps.

10. A HFCC therapy system comprising:
a garment having an air bladder adapted to engage at least a portion of a patient;
an air pulse generator including an air fan and a valve to produce an air pressure and high frequency air pressure pulses;
a controller for regulating operation of the air pulse generator to manage the time duration of operation of the air fan, the frequency of the air pulses and the air pressure produced by the generator;
a memory device for storing at least a set of operating parameters of the air pulse generator; and
a display coupled to a housing, the display is signaled by software of the therapy system to display a data download screen, the data download screen comprising session data or summary data associated with prior therapy sessions.

11. The HFCC therapy system of claim 10 wherein the session data includes one or more of: User ID; Device number; Start and stop date of session; Start time; Stop time; Total time; Pause time; Therapy time; Start pressure; End pressure; Average pressure; Program; Maximum measured frequency from valve motor hall sensor; Minimum frequency setting for session; Maximum frequency setting for session; Number of program steps performed; Number of pauses initiated (manual or automatic); and Termination type.

12. The HFCC therapy system of claim 10 wherein the summary data includes one or more of: User ID or Device ID; Date of session; Program used; Total time of session; runtime of session; Total pause time of session; Number of pauses per session; Number of steps in session; and Average pressure of session.

13. The HFCC therapy system of claim 10 wherein the session data or summary data are wireless communicated to a remote location.

14. The HFCC therapy system of claim 13 wherein the remote location is a portable wireless device.

15. The HFCC therapy system of claim 14 wherein the session or summary data are displayed to the patient or caregiver on the portable wireless device.

16. A method of using an HFCC therapy system comprising:
providing a patient with a garment having an air bladder adapted to engage at least a portion of a patient;
activating an air pulse generator including an air fan and a valve to produce an air pressure and high frequency air pressure pulses;
using a controller to regulate operation of the air pulse generator to manage the time duration of operation of the air fan, the frequency of the air pulses and the air pressure produced by the generator;
storing with a memory device at least a set of operating parameters of the air pulse generator; and
displaying, in response to a signal from software of the therapy system, one or more data download screens comprising session data or summary data associated with prior therapy sessions.

17. The method of claim 16 wherein the session data includes one or more of: User ID; Device number; Start and stop date of session; Start time; Stop time; Total time; Pause time; Therapy time; Start pressure; End pressure; Average pressure; Program; Maximum measured frequency from valve motor hall sensor; Minimum frequency setting for session; Maximum frequency setting for session; Number of program steps performed; Number of pauses initiated (manual or automatic); and Termination type.

18. The method of claim 16 wherein the summary data includes one or more of: User ID or Device ID; Date of session; Program used; Total time of session; runtime of session; Total pause time of session; Number of pauses per session; Number of steps in session; and Average pressure of session.

19. The method of claim 16 wherein the session data or summary data are wirelessly communicated to a remote location.

20. The method of claim 19 wherein the session or summary data are displayed to the patient or caregiver on the portable wireless device.
